(19) United States
(12) Patent Application Publication
(10) Pub. No.: US 2014/0101106 A1
(43) Pub. Date: Apr. 10, 2014

(54) LOG SERVER AND LOG FILE STORAGE METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); BIN ZHENG, Shenzhen (CN); HAO ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/952,682

(22) Filed: Jul. 29, 2013

(30) Foreign Application Priority Data
Oct. 9, 2012 (CN) 2012103788703

(51) Int. Cl. G06F 17/30

(52) U.S. Cl. CPC G06F 17/30227
USPC 707/648

(57) ABSTRACT

A log server is electronically connected to one or more hosts. The log server sends a scan command to all storage nodes connected to a host. The host obtains a log file from each storage node connected to the host, and transmits the log file and an identifier of the storage node to the log server. The log server then searches previously stored log files in relation to the storage node in a storage device according to the identifier, and determines if the received log file is an updated log file based on the search result. If the received log file is an updated log file, the log server stores the received log file into the storage device. Otherwise, if the received log file is not an updated log file, the log server abandons the received log file.

### BACKGROUND

1. Technical Field

Embodiments of the present disclosure relate to cloud computing technology, and more particularly to a log server and a log file storage method.

2. Description of related art

Input/output operations per second (IOPS) is a common performance measurement used to benchmark computer storage devices, such as hard disk drives (HDDs), solid state drives (SSDs), and storage area networks (SANs). In cloud computing (often simply referred to as a “cloud”), to ensure reliability of the “cloud,” IOPS tests are frequently performed on storage nodes (e.g., HDD, SSD, SAN) in the cloud. There may be a huge amount of storage nodes distributed in a dispersed manner in the cloud, so that a huge number of log files are generated from the IOPS tests. How to efficiently obtain and store the huge amount of log files is desired.

### BRIEF DESCRIPTION OF THE DRAWINGS

FIG. 1 is a block diagram of one embodiment of an application environment of a log file storage system.

FIG. 2 is a block diagram of one embodiment of function modules of the log file storage system in FIG. 1.

FIG. 3 is a flowchart of one embodiment of a log file storage method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

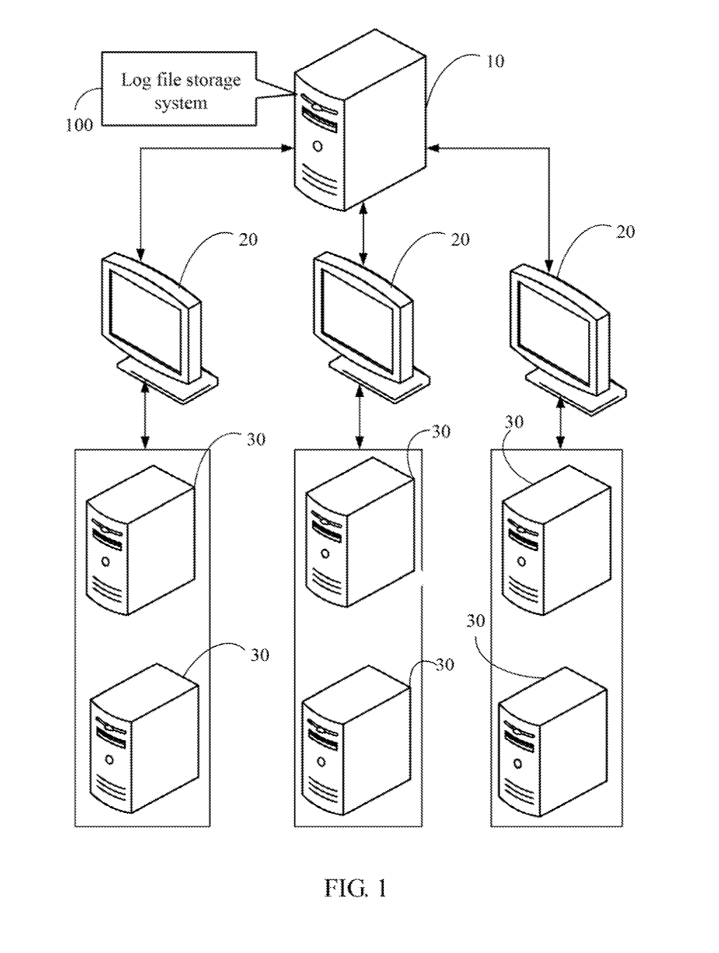

FIG. 1 is a block diagram of one embodiment of an application environment of a log file storage system 100 (hereinafter the “system 10”). The system 100 is installed in a log server 10. The log server 10 is electronically connected to a plurality of hosts 20. Each host 20 connects with one or more storage nodes 30 via networks or signal transmission wires. Depending on the embodiment, a host 20 may be a computer, a server, or a virtual machine, which is installed with a log file probe. The log file probe is a script program which reads log files generated from IOPS tests (IOPS test log files), from the storage nodes 30. The log file probe may be created using a webpage programming language, such as ASP, PHP, or ASP.NET, for example. Types of the storage nodes 30 may include hard disk drives (HDDs), solid state drives (SSDs), and storage area networks (SANs), for example. A storage node 30 may be any other physical machine or a virtual machine that provides data storage functions.

In one embodiment, the log server 10 includes a configuration file, which records configuration information of the hosts 20 and the storage nodes 30. The configuration information of each host 20 includes an identifier, an IP address, hardware resource configuration (e.g., CPU resource, memory resource, network bandwidth) of the host 20, and configuration information in relation to one or more storage nodes 30 which are connected to the host 20. The configuration information in relation to each storage nodes 30 includes an identifier, a location, a type, and a storage capacity of the storage node 30.

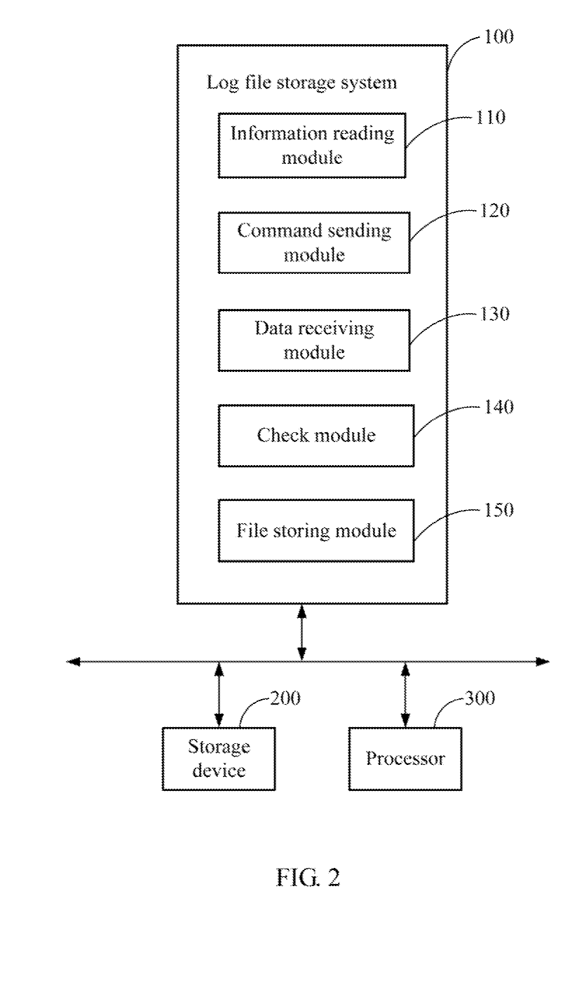

As shown in FIG. 2, the log server 10 further includes a storage device 200 and a processor 300. The storage device 200 stores the configuration file and IOPS test log files (hereinafter simply referred to as “log files”) in relation to the one or more storage nodes 30. As mentioned above, a log file probe is installed in each host 20, to monitor the storage nodes 30 connected to the host 20. When an IOPS test is carried out at one storage node 30 connected to the host 20, a log file is generated in the storage node 30. Each log file stored in the storage device 200 is associated with an identifier of a storage node 30 in which the log file is generated. For example, if a storage node 30 has an identifier “node A,” and a log file B is generated in the storage node 30, the log file B may be associated with the identifier “node A” and then the associated log file B is stored into the storage device 200.

When the system 100 sends a scan command of scanning the storage node 30 to the host 20, the log file probe of the host 20 retrieves the log file from the storage node 30, the host 20 transmits the identifier of the storage node 30 and the log file of the storage node 30 to the system 100. The system 100 receives the identifier and the log file, and checks if the storage device 200 has already stored a log file of the storage node 30 by searching the storage device according to the identifier. The system 100 then determines if the received log file is the same as the stored log file. If the received log file is identical to the stored log file, the system 100 abandons the received log file, so as to avoid the duplication of any storing operations. If the received log file is different from the stored log file, the system 100 determines that the received log file is an updated log file, and stores the received log file in the storage device 200.

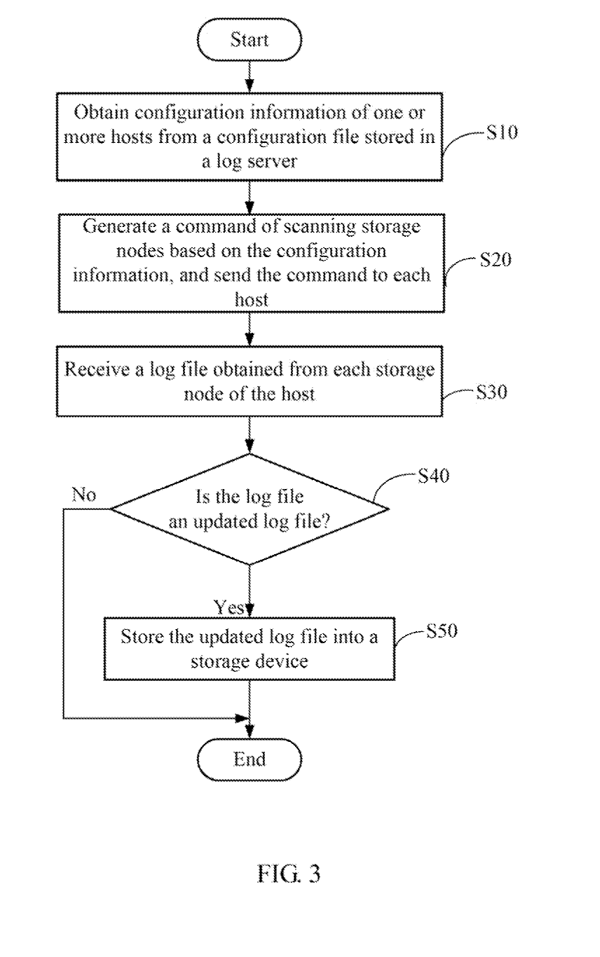

As shown in FIG. 2, the system 100 includes a plurality of function modules, such as an information reading module 110, a command sending module 120, a data receiving module 130, a check module 140, and a file storing module 150. The modules 110-150 include computerized code in the form of one or more programs, which are stored in the storage device 200 of the log server 10. A processor 300 of the log server 10 executes instructions of the one or more programs, to provide the aforementioned functions of the system 100. Detailed functions of the modules 11-14 are given in reference to FIG. 3.

FIG. 3 is a flowchart of one embodiment of a log file storage method. Depending on the embodiment, additional steps may be added, others removed, and the ordering of the steps may be changed.

In step S10, the information reading module 110 reads configuration information of one or more hosts 20 from the configuration file stored in the storage device 200. As mentioned above, the configuration information of the one or more hosts 20 includes an identifier, an IP address, and hardware resource configuration (e.g., CPU resource, memory resource, network bandwidth) of each host 20.

In step S20, the command sending module 120 generates a scan command to scan the storage nodes 30, and sends the scan command to the one or more hosts 20. In this embodiment, the scan command includes an IP address of each of the one or more hosts 20, and the scan command is sent to each host 20 according to the IP address of the host 20. After receiving the scan command, the host 20 scans all storage nodes 30 of the host 20, obtains a log file from each storage node 30 of the host 20 using a log file probe installed in the host 20, and transmits an identifier of the storage node 30 and the log file to the log server 10.

In step S30, the data receiving module 130 receives the identifier and the log file of the storage node 30 sent by the host 20.

In step S40, the check module 140 searches one or more previously stored log files in relation to the storage node 30 according to the identifier of the storage node 30, and determines if the received log file is an updated log file of the storage node 30 based on the search result. As mentioned above, each log file stored in the storage device 200 has an association with an identifier of a storage node 30 in which the log file is generated, so that the check module 140 can search all log files in relation to the storage node 30 in the storage device 200 according to the identifier of the storage node 30.

In this embodiment, if the check module 140 determines no log file in relation to the storage node 30 has been previously stored in the storage device 200, the check module 140 determines that the received log file is an updated log file of the storage node 30. If one or more previously stored log files in relation to the storage node 30 have been searched in the storage device 200, the check module 140 compares the received log file with each searched log file, and determines if the content of the received log file is the same as content of any searched log file. If the content of the received log file is the same as the content of any searched log file, the check module 140 determines that the received log file is not an updated log file, and the storing module 150 abandons the receive log file, the procedure ends. Otherwise, if the content of the received log file is different from the content of any searched log file, the check module 140 determines that the received log file is an updated log file, and the procedure goes to step S50.

In step S50, the storing module 150 stores the received log file into the storage device 200.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a log server, the log server being electronically connected to one or more hosts, and each host being connected to one or more storage nodes, the method comprising steps:
(a) reading configuration information of the one or more hosts from a configuration file stored in a storage device;
(b) generating a scan command to scan the one or more storage nodes according to the configuration information, and sending the scan command to the one or more hosts;
(c) receiving, from each host, a log file generated in each storage node of the host and an identifier of the storage node;
(d) searching one or more previously stored log files in relation to the storage node in the storage device according to the identifier of the storage node, and determining if the received log file is an updated log file of the storage node based on the search result; and
(e) abandoning the received log file in response to a determination that the received log file is not an updated log file of the storage node, or (f) storing the received log file into the storage device in response to a determination that the received log file is an updated log file of the storage node.

2. The method as claimed in claim 1, wherein each log file stored in the storage device is associated with an identifier of a storage node in which the log file is generated.

3. The method as claimed in claim 1, wherein step (d) comprises:
in response to the search result that no log file in relation to the storage node has been previously stored in the storage device, determining the received log file is the updated log file of the storage node;
in response to the search result that one or more previously stored log files in relation to the storage node have been searched in the storage device, comparing the received log file with each searched log file, and determining if content of the received log file is the same as content of any searched log file; and
determining that the received log file is not the updated log file if the content of the received log file is the same as the content of any searched log file, or determining that the received log file is the updated log file if the content of the received log file is different from the content of any searched log file.

4. The method of claim 1, wherein the host obtains a log file from each storage node connected to the host by a log file probe.

5. The method of claim 1, wherein the configuration information of each host comprises an identifier, an IP address, hardware resource configuration of the host, and configuration information in relation to each storage node that is connected to the host.

6. The method of claim 5, wherein the configuration information in relation to each storage node comprises an identifier, a location, a type, and a storage capacity of the storage node.

7. A non-transitory computer-readable medium having stored thereon instructions that, when executed by a processor of a log server, cause the processor to perform operations of:
(a) reading configuration information of one or more hosts, which are electronically connected to the log server, from a configuration file stored in a storage device;
(b) generating a scan command to scan one or more storage nodes according to the configuration information, and sending the scan command to the one or more hosts, wherein the one or more storage nodes are connected to the one or more hosts;
(c) receiving, from each host, a log file generated in each storage node of the host and an identifier of the storage node;
(d) searching one or more previously stored log files in relation to the storage node in the storage device according to the identifier of the storage node, and determining if the received log file is an updated log file of the storage node based on the search result; and
(e) abandoning the received log file in response to a determination that the received log file is not an updated log file of the storage node, or (f) storing the received log file into the storage device in response to a determination that the received log file is an updated log file of the storage node.

8. The medium as claimed in claim 7, wherein each log file stored in the storage device is associated with an identifier of a storage node in which the log file is generated.

9. The medium as claimed in claim 7, wherein operation (d) comprises:
in response to the search result that no log file in relation to the storage node has been previously stored in the storage device, determining the received log file is the updated log file of the storage node;
in response to the search result that one or more previously stored log files in relation to the storage node have been searched in the storage device, comparing the received log file with each searched log file, and determining if content of the received log file is the same as content of any searched log file; and
determining that the received log file is not the updated log file if the content of the received log file is the same as the content of any searched log file, or determining that the received log file is the updated log file if the content of the received log file is different from the content of any searched log file.

10. The medium of claim 7, wherein the host obtains a log file from each storage node connected to the host by a log file probe.

11. The medium of claim 7, wherein the configuration information of each host comprises an identifier, an IP address, hardware resource configuration of the host, and configuration information in relation to each storage node that is connected to the host.

12. The medium of claim 11, wherein the configuration information in relation to each storage node comprises an identifier, a location, a type, and a storage capacity of the storage node.

13. A log server being electronically connected to one or more hosts, and each host being connected to one or more storage nodes, the log server comprising:
a processor; and
a storage device that stores a configuration file and one or more programs that, when executed by the processor, cause the processor to perform operations of:
(a) reading configuration information of one or more hosts, which are electronically connected to the log server, from the configuration file stored in the storage device;
(b) generating a scan command to scan one or more storage nodes according to the configuration information, and sending the scan command to the one or more hosts, wherein the one or more storage nodes are connected to the one or more hosts;
(c) receiving, from each host, a log file generated in each storage node of the host and an identifier of the storage node;
(d) searching one or more previously stored log files in relation to the storage node in the storage device according to the identifier of the storage node, and determining if the received log file is an updated log file of the storage node based on the search result; and
(e) abandoning the received log file in response to a determination that the received log file is not an updated log file of the storage node, or (f) storing the received log file into the storage device in response to a determination that the received log file is an updated log file of the storage node.

14. The log server as claimed in claim 13, wherein each log file stored in the storage device is associated with an identifier of a storage node in which the log file is generated.

15. The log server as claimed in claim 13, wherein operation (d) comprises:
in response to the search result that no log file in relation to the storage node has been previously stored in the storage device, determining the received log file is the updated log file of the storage node;
in response to the search result that one or more previously stored log files in relation to the storage node have been searched in the storage device, comparing the received log file with each searched log file, and determining if content of the received log file is the same as content of any searched log file; and
determining that the received log file is not the updated log file if the content of the received log file is the same as the content of any searched log file, or determining that the received log file is the updated log file if the content of the received log file is different from the content of any searched log file.

16. The log server of claim 13, wherein the host obtains a log file from each storage node connected to the host by a log file probe.

17. The log server of claim 13, wherein the configuration information of each host comprises an identifier, an IP address, hardware resource configuration of the host, and configuration information in relation to each storage node that is connected to the host.

18. The log server of claim 17, wherein the configuration information in relation to each storage node comprises an identifier, a location, a type, and a storage capacity of the storage node.
